(19) United States
(12) Patent Application Publication
(10) Pub. No.: US 2003/0173422 A1
(43) Pub. Date: Sep. 18, 2003

(54) Nozzle device of foam fire extinguisher

(76) Inventor: Ching-Chung Lee, Miao Li Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/095,093

(22) Filed: Mar. 12, 2002

(51) Int. Cl. B05B 1/34

(52) U.S. Cl. 239/474

(57) ABSTRACT

A nozzle device of a foam fire extinguisher includes a main body, and a sleeve. The main body is formed with an extension bar which has a first portion formed with an annular groove, and a second portion formed with an annular limit groove. The annular groove has a wall formed with at least one side flow hole communicating with the annular groove and the passage. The sleeve is mounted on the extension bar, and has an inner wall having a first side formed with an opening, and a second side formed with a closed face which is formed with an injection hole. The inner wall of the sleeve is formed with an annular insertion groove for insertion of a limit ring which is limited to move in the limit groove of the extension bar.

### BACKGROUND OF THE INVENTION

1. Field of the Invention

The present invention relates to a nozzle device of a foam fire extinguisher, and more particularly to a nozzle device of a foam fire extinguisher, wherein the injection state of the extinguishing foam liquid may be adjusted.

2. Description of the Related Art

A conventional foam fire extinguisher 4A in accordance with the prior art shown in FIG. 6 comprises a container 40A filled with foam liquid that may extinguish the fire, a valve 41A mounted on the top of the container 40A, a press bar 42A mounted on the valve 41A to control injection of the foam liquid contained in the container 40A, and a nozzle 60 secured on the valve 41A. The nozzle 60 has a first end formed with a threaded portion 61 screwed into the valve 41A, and a second end formed with an injection hole 63. The nozzle 60 has a center formed with a passage 62 communicating with the valve 41A and the injection hole 63. In use, the press bar 42A mounted on the valve 41A may be pressed, so that the foam liquid contained in the container 40A may be conveyed through the valve 41A and the passage 62, and may be injected outward through the injection hole 63 of the nozzle 60 to extinguish the fire.

However, the conventional foam fire extinguisher 4A in accordance with the prior art has the following disadvantages.

1. The nozzle 60 cannot adjust the injection state of the foam liquid, so that the diffusion angle of the injected foam liquid is fixed, and cannot be adjusted. Thus, if the fire has a larger area, the foam liquid cannot entirely cover the fire to isolate the air, so that the fire will continue to burn, thereby affecting the extinguishing effect.

2. The injected liquid that is contained in the container 40A will produce a great deal of foam after contacting the air. Thus, the injected liquid will form the foam after being injected from the nozzle 60 through a determined distance, so that some liquid does not form the foam when reaching the fire, thereby affecting the extinguishing effect.

3. The nozzle 60 has a fixed injection travel. Thus, the user has to approach the fire source to extinguish the fire, thereby causing danger to the user.

### SUMMARY OF THE INVENTION

The present invention has arisen to mitigate and/or obviate the disadvantage of the conventional foam fire extinguisher.

The primary objective of the present invention is to provide a nozzle device of a foam fire extinguisher, wherein the injection state of the extinguishing foam liquid may be adjusted.

Another objective of the present invention is to provide a nozzle device of a foam fire extinguisher, wherein the injected extinguishing foam liquid may produce a great deal of foam rapidly, thereby increasing the fire extinguishing efficiency.

A further objective of the present invention is to provide a nozzle device of a foam fire extinguisher, wherein the movement field of the sleeve may be adjusted and limited, so that the injected extinguishing foam liquid may have the optimum shooting travel and field.

A further objective of the present invention is to provide a nozzle device of a foam fire extinguisher, wherein the injection distance of the injected extinguishing foam liquid may be adjusted efficiently.

In accordance with the present invention, there is provided a nozzle device of a foam fire extinguisher, comprising a main body, and a sleeve, wherein:

the main body has a first end formed with a combination portion, and a second end formed with an extension bar, the extension bar has an inner wall formed with a passage, the extension bar has a first portion formed with an annular groove, and a second portion connected to the combination portion and formed with an annular limit groove, the annular groove has a wall radially formed with at least one side flow hole communicating with the annular groove and the passage, the extension bar is formed with an outer thread; and

the sleeve is formed with a receiving chamber for receiving the extension bar of the main body, the receiving chamber of the sleeve has an inner wall having a first side formed with an opening, and a second side formed with a closed face which is formed with an injection hole, the inner wall of the receiving chamber of the sleeve is formed with an inner thread screwed on the outer thread of the extension bar of the main body, the inner wall of the receiving chamber of the sleeve is formed with an annular insertion groove for insertion of a limit ring which is limited to move in the limit groove of the extension bar of the main body.

Preferably, the first portion of the extension bar of the main body has a center formed with a recess.

Preferably, the first portion of the extension bar of the main body has a periphery formed with two radially opposite oblique guide channels each having a first side communicating with the recess and a second side passed through the annular flange.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a nozzle device of a foam fire extinguisher in accordance with a first embodiment of the present invention;

FIG. 2 is a cross-sectional perspective assembly view of a nozzle device of a foam fire extinguisher in accordance with a first embodiment of the present invention;

FIG. 3 is a side plan cross-sectional assembly view of the nozzle device of a foam fire extinguisher as shown in FIG. 2;

FIG. 4 is a side plan cross-sectional assembly view of the nozzle device of a foam fire extinguisher as shown in FIG. 2;

FIG. 5 is a side plan cross-sectional assembly view of a nozzle device of a foam fire extinguisher in accordance with a second embodiment of the present invention; and

FIG. 6 is a side plan partially cross-sectional assembly view of a conventional foam fire extinguisher in accordance with the prior art.

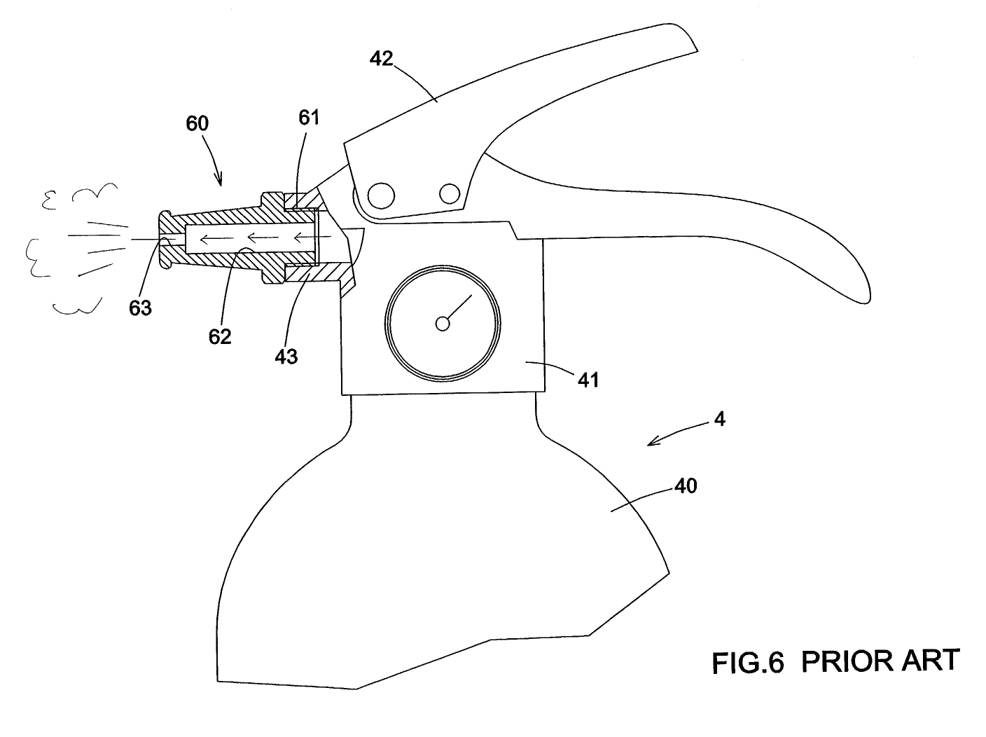

### DETAILED DESCRIPTION OF THE INVENTION

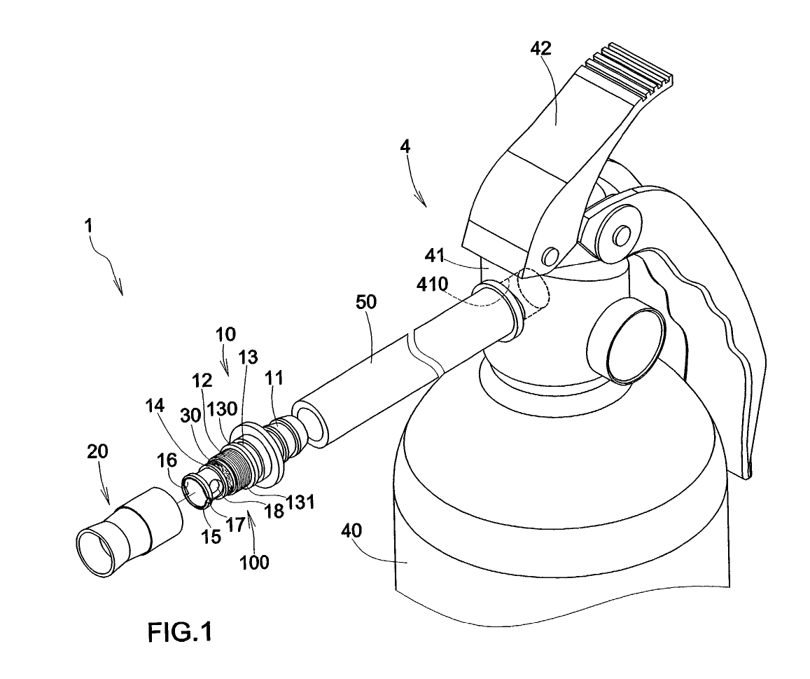

Referring to the drawings and initially to FIGS. 1-3, a nozzle device 1 of a foam fire extinguisher 4 in accordance with a first embodiment of the present invention is shown.

The foam fire extinguisher 4 comprises a container 40 filled with foam liquid that may extinguish the fire, a valve 41 mounted on the top of the container 40, a press bar 42 mounted on the valve 41 to control injection of the foam liquid contained in the container 40, and an injection spout 410 mounted on one side of the valve 41. The injection spout 410 communicates with the inside of the valve 41. A conducting pipe 50 has a first end secured to the injection spout 410 of the valve 41, and a second end combined with the nozzle device 1.

The nozzle device 1 comprises a main body 10, and a sleeve 20.

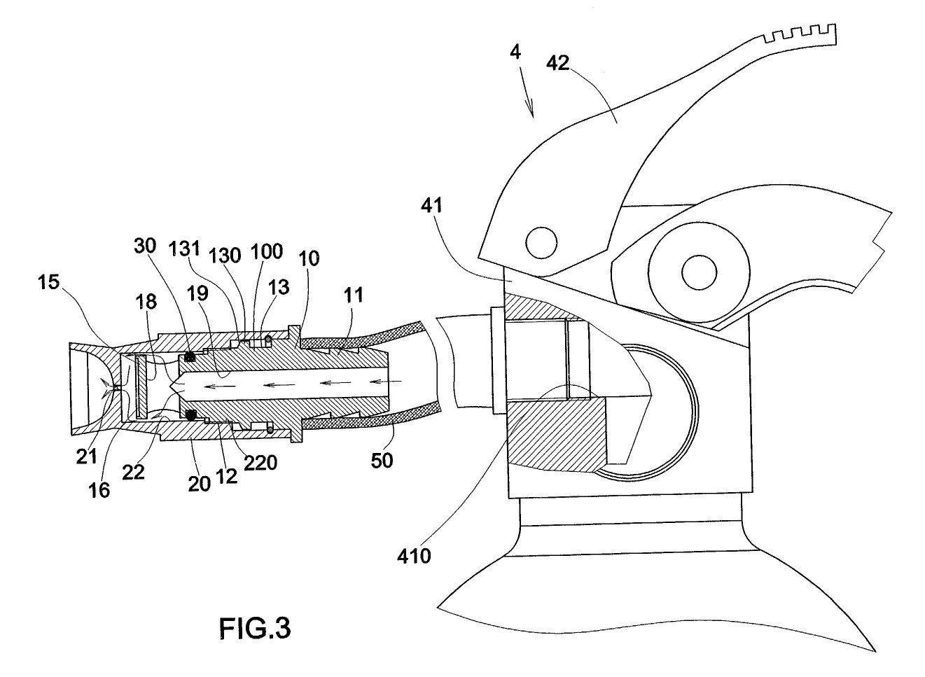

As shown in FIGS. 1 and 3, the main body 10 has a first end formed with a combination portion 11 that may be inserted into the second end of the conducting pipe 50, and a second end formed with an extension bar 100.

The extension bar 100 has an inner wall formed with a passage 19 (see FIG. 3) communicating with the conducting pipe 50 which communicates with the injection spout 410 of the valve 41. The extension bar 100 has a first portion formed with an annular flange 15 and an annular groove 14 spaced from the annular flange 15. The annular groove 14 has a wall formed with two radially opposite side flow holes 18 (see FIG. 1) communicating with the annular groove 14 and the passage 19. The first portion of the extension bar 100 has a center formed with a recess 16, and has a periphery formed with two radially opposite oblique guide channels 17 each having a first side communicating with the recess 16 and a second side passed through the annular flange 15. The nozzle device 1 further comprises a leakproof ring 30 mounted on the extension bar 100 and located adjacent to the annular groove 14. The extension bar 100 has a second portion connected to the combination portion 11 and formed with an annular limit groove 13 having a determined width. The extension bar 100 is formed with an outer thread 12 located between the limit groove 13 and the leakproof ring 30, and formed with a catch flange 130 located between the limit groove 13 and the outer thread 12. The catch flange 130 is formed with an inclined face 131 directed toward the outer thread 12.

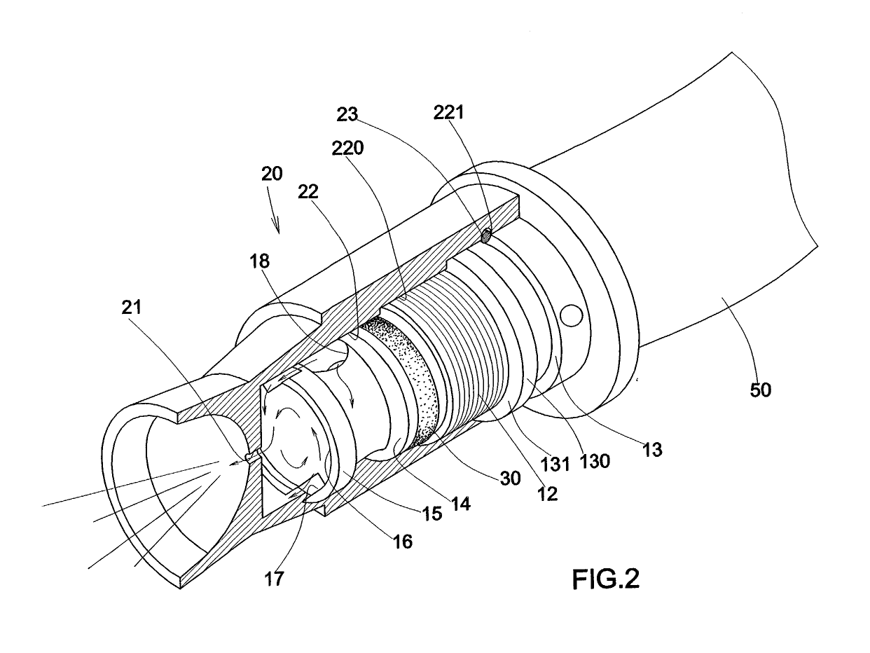

As shown in FIGS. 2 and 3, the sleeve 20 is a cylindrical body, and is formed with a receiving chamber 22 for receiving the extension bar 100 of the main body 10. The receiving chamber 22 of the sleeve 20 has an inner wall having a first side formed with an opening, and a second side formed with a closed face which is formed with an injection hole 21. The inner wall of the receiving chamber 22 of the sleeve 20 is formed with an inner thread 220 screwed on the outer thread 12 of the extension bar 100 of the main body 10. The inner wall of the receiving chamber 22 of the sleeve 20 is formed with an annular insertion groove 221 located adjacent to the opening of the first side of the sleeve 20. A limit ring 23 is inserted into the insertion groove 221 of the receiving chamber 22 of the sleeve 20, and is limited to move in the limit groove 13 of the extension bar 100 of the main body 10, thereby limiting the sleeve 20 to move in the optimum adjustment range, so as to prevent the sleeve 20 from being rotated excessively to detach from the main body 10.

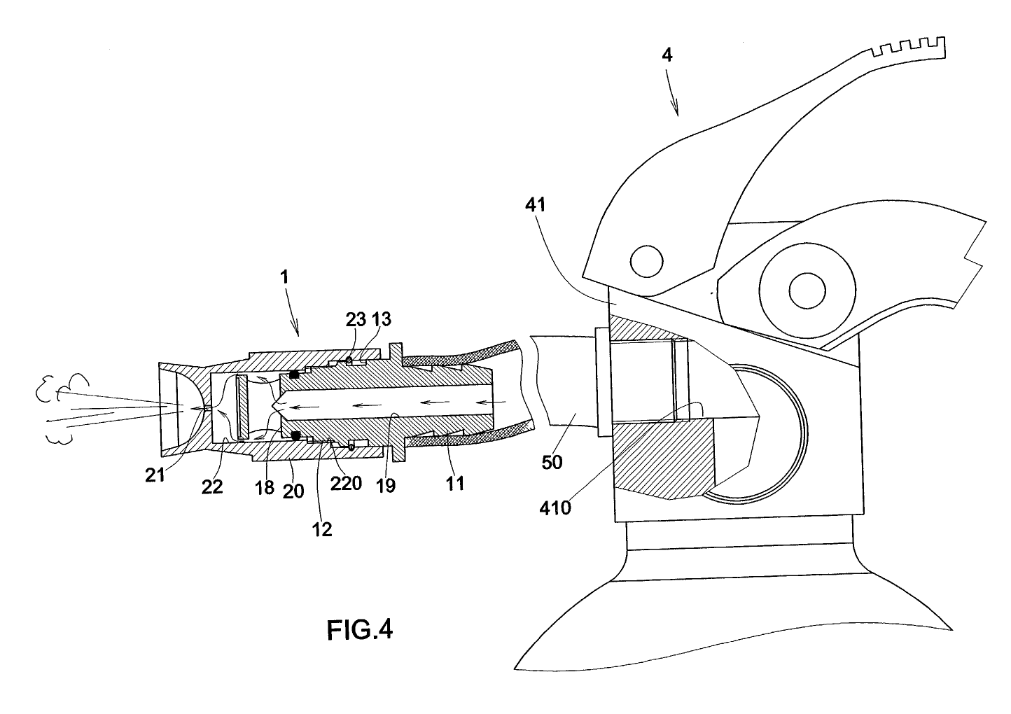

In operation, referring to FIGS. 3 and 4, when the press bar 42 mounted on the valve 41 of the foam fire extinguisher 4 is pressed, the extinguishing foam liquid contained in the container 40 of the foam fire extinguisher 4 is released to flow through the injection spout 410 of the valve 41 and the conducting pipe 50, and rapidly flow to the nozzle device 1 at the distal end of the conducting pipe 50. Then, the extinguishing foam liquid flushes into the passage 19 of the extension bar 100 of the main body 10, flows through the side flow holes 18, flows through the gap defined between the annular flange 15 of the extension bar 100 of the main body 10 and the receiving chamber 22 of the sleeve 20, and flows into the space defined between the end face of the extension bar 100 of the main body 10 and the closed face of the receiving chamber 22 of the sleeve 20. A part of the extinguishing foam liquid flows through the guide channels 17 of the extension bar 100 of the main body 10 into the recess 16, thereby forming a helical high speed circulation as indicated by the arrows as shown in FIG. 2. The helical high speed circulation liquid will draw the liquid in the receiving chamber 22 of the sleeve 20 to form a helical eddy which will hit the closed face of the receiving chamber 22 of the sleeve 20, and will be strongly injected outward from the injection hole 21 of the sleeve 20, thereby efficiently increasing the injection distance and the efficiency of the extinguishing foam liquid.

In addition, when the extinguishing foam liquid hits the closed face of the receiving chamber 22 of the sleeve 20, the extinguishing foam liquid will produce a great deal of foam instantaneously, so that the extinguishing foam liquid will form the foam as soon as the extinguishing foam liquid is injected outward from the injection hole 21 of the sleeve 20, so as to entirely cover the fire source and isolate the air, thereby extinguishing the fire rapidly.

When the fire source has a larger field, the sleeve 20 may be rotated to move toward the main body 10, thereby shortening the distance between the end face of the extension bar 100 of the main body 10 and the closed face of the receiving chamber 22 of the sleeve 20, so that the extinguishing foam liquid may be injected outward from the injection hole 21 of the sleeve 20 in a helical diffusion manner to cover a larger area as shown in FIG. 3. Thus, the extinguishing foam liquid may entirely cover the larger fire source and isolate the air, thereby extinguishing the fire rapidly.

On the contrary, when the fire source has a smaller field, the sleeve 20 may be rotated to move outward relative to the main body 10, thereby increasing the distance between the end face of the extension bar 100 of the main body 10 and the closed face of the receiving chamber 22 of the sleeve 20, so that the extinguishing foam liquid may be injected outward from the injection hole 21 of the sleeve 20 in a stronger and more concentrated manner to cover a smaller area as shown in FIG. 4. Thus, the extinguishing foam liquid may entirely cover the smaller fire source and isolate the air, thereby extinguishing the fire rapidly.

Accordingly, in the nozzle device 1 of a foam fire extinguisher 4 in accordance with a first embodiment of the present invention, the sleeve 20 may be rotated relative to the main body 10, so as to adjust the distance between the end face of the extension bar 100 of the main body 10 and the closed face of the receiving chamber 22 of the sleeve 20 according to the field of the fire source, so that the extinguishing foam liquid may be injected outward from the injection hole 21 of the sleeve 20 in a diffusion manner as shown in FIG. 3 or in a concentration manner as shown in FIG. 4. Thus, the extinguishing foam liquid may entirely cover the smaller fire source and isolate the air, thereby extinguishing the fire rapidly.

In addition, the limit ring 23 locked in the insertion groove 221 of the receiving chamber 22 of the sleeve 20 is limited to move in the limit groove 13 of the extension bar 100 of the main body 10, thereby limiting the sleeve 20 to move in the limit groove 13 of the extension bar 100 of the main body 10, so as to obtain the optimum adjustment range of the distance between the end face of the extension bar 100 of the main body 10 and the closed face of the receiving chamber 22 of the sleeve 20, thereby facilitating the user rotating the sleeve 20 to adjust the distance between the end face of the extension bar 100 of the main body 10 and the closed face of the receiving chamber 22 of the sleeve 20. Further, when the sleeve 20 is rotated to the limit, the limit ring 23 of the sleeve 20 is stopped by the catch flange 130 of the extension bar 100 of the main body 10, so that the limit groove 13 of the extension bar 100 of the main body 10 may prevent the sleeve 20 from being rotated excessively to detach from the main body 10.

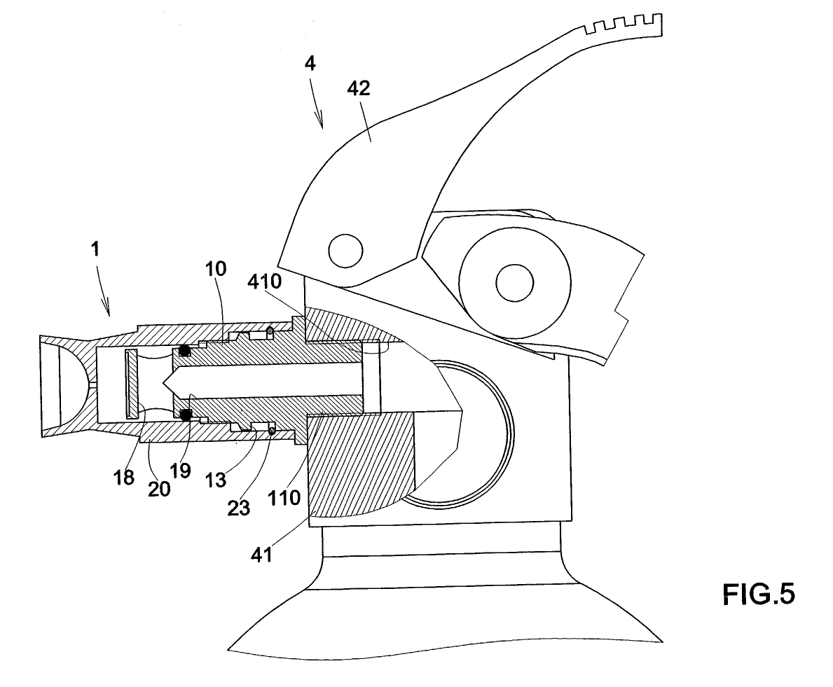

Referring to FIG. 5 a nozzle device 1 of a foam fire extinguisher 4 in accordance with a second embodiment of the present invention is shown.

The combination portion 11 of the main body 10 of the nozzle device 1 is directly formed with an outer thread 110 screwed into the injection spout 410 of the valve 41, so that the nozzle device 1 may be directly secured on the valve 41.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A nozzle device of a foam fire extinguisher, comprising a main body, and a sleeve, wherein:
the main body has a first end formed with a combination portion, and a second end formed with an extension bar, the extension bar has an inner wall formed with a passage, the extension bar has a first portion formed with an annular groove, and a second portion connected to the combination portion and formed with an annular limit groove, the annular groove has a wall radially formed with at least one side flow hole communicating with the annular groove and the passage, the extension bar is formed with an outer thread; and
the sleeve is formed with a receiving chamber for receiving the extension bar of the main body, the receiving chamber of the sleeve has an inner wall having a first side formed with an opening, and a second side formed with a closed face which is formed with an injection hole, the inner wall of the receiving chamber of the sleeve is formed with an inner thread screwed on the outer thread of the extension bar of the main body, the inner wall of the receiving chamber of the sleeve is formed with an annular insertion groove for insertion of a limit ring which is limited to move in the limit groove of the extension bar of the main body.

2. The nozzle device of a foam fire extinguisher in accordance with claim 1, wherein the first portion of the extension bar of the main body has a center formed with a recess.

3. The nozzle device of a foam fire extinguisher in accordance with claim 2, wherein the first portion of the extension bar of the main body has a periphery formed with two radially opposite oblique guide channels each having a first side communicating with the recess and a second side passed through the annular flange.
